(19) United States
(12) Patent Application Publication
(10) Pub. No.: US 2008/0039583 A1
(43) Pub. Date: Feb. 14, 2008

(54) Adhesive composition

(76) Inventors: I-Hwa Lee, Wilmington, DE (US); David H. Putscher, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/500,709

(22) Filed: Aug. 8, 2006

(51) Int. Cl. C08L 51/04; B32B 27/36; C08F 290/04; B32B 27/08

(52) U.S. Cl. 525/71; 524/504; 428/480; 428/35.7

(57) ABSTRACT

A composition comprises two or more ethylene copolymers, including a grafted ethylene copolymer; a tackifier, and two or more styrene polymers. The styrene polymers comprise an ABA block copolymer and one or both of a high impact polystyrene and an AB block copolymer. The composition may be used as an adhesive or tie layer. In particular, the composition may used to adhere articles comprising polystyrene, preferably to other articles comprising more polar materials, such as copolymers of ethylene and vinyl alcohol (EVOH), for example.

### BACKGROUND OF THE INVENTION

1. Field of the Invention

The present invention relates to the field of polymer compositions, and, in particular, to polymer compositions that are useful as adhesives or as tie layers.

2. Description of the Related Art

Several patents and publications are cited in this description in order to more fully describe the state of the art to which this invention pertains. The entire disclosure of each of these patents and publications is incorporated by reference herein.

Increasing the effectiveness of adhesives is an important industrial goal. In particular, adhesives that are useful in binding together the layers of a multilayer film or sheet are known as “tie layers.” Typically, the individual layers are chosen so that the multilayer structure is provided with a variety of properties that cannot feasibly be provided by a single material. In order to be effective in such configurations, a tie layer composition must be chemically compatible with materials having widely varying properties.

Polystyrene is a material with many industrial uses. In particular, polystyrene barrier sheets have been available for many years. In packaging applications, polystyrene barrier sheet is thermoformed into cups, tubs or trays for packaging foodstuffs such as dairy products, fruit products, puddings, cheese spreads, and the like.

Polystyrene barrier sheets may have multiple layers, generally with a polystyrene outer layer, where the polystyrene could be general purpose polystyrene, medium impact polystyrene, high impact polystyrene, or a blend of impact polystyrenes with general purpose polystyrene. The inner food contact layer is typically polyethylene, for example low density polyethylene. Interposed between these layers are a barrier layer, typically ethylene vinyl alcohol or nylon, and one or more tie layers. A regrind layer including recycled material is also commonly included in such structures.

More specifically, a typical structure for a polystyrene barrier sheet is PS/tie/EVOH/tie/PE, where “PS” refers to polystyrene, “tie” refers to an adhesive or tie layer, “EVOH” refers to a copolymer of ethylene and vinyl alcohol, “PE” refers to polyethylene, and “1” indicates adjacent layers. Other typical structures include PS/Regrind/tie/EVOH/tie/PE, and PS/PS/Regrind/tie/EVOH/tie/PE, where the two outer layers of polystyrene could incorporate various combinations of general purpose polystyrene with impact polystyrenes and other styrenic polymers.

One class of tie layers known in the art consists of anhydride-modified copolymers of ethylene and vinyl acetate (EVA). See, for example, the tie layers that are described in U.S. Pat. Nos. 4,861,676 and 4,861,677. Adhesives comprising EVA, however, may have inadequate thermal resistance, for example in applications that require hot filling of a product into thermoformed containers fabricated from the PS barrier sheet. Adhesives comprising PE generally have better thermal resistance than adhesives comprising EVA or ethylene-methyl acrylate copolymers (EMA). Unlike EVA, though, PE is incompatible with PS and, therefore, adhesives comprising PE do not bond sufficiently well to PS layers, particularly in coextruded structures.

In this connection, U.S. Pat. No. 5,591,792, issued to Hattori et al., describes an adhesive resin composition that comprises an ethylene polymer and/or a modified product thereof with an unsaturated carboxylic acid or its derivative; a tackifier; and a block copolymer containing at least one polymer block mainly composed of a vinyl aromatic hydrocarbon and at least one polymer block mainly composed of a conjugated diene or a hydrogenated product thereof. The composition is reported to exhibit excellent adhesion over a wide temperature range and that is processible by film molding, sheet molding, and blow molding, for example. Moreover, the adhesive is useful in laminates comprising resins such as polyolefins, styrenic resins, polyesters, acrylic resins and polyamides.

It is apparent from the foregoing that there remains a need for polymer compositions that are useful as adhesives or tie layers, that have higher thermal resistance than adhesives based on ethylene-vinyl acetate copolymers, and that bond well to polystyrene in coextruded structures.

### SUMMARY OF THE INVENTION

Provided herein is a composition comprising two or more ethylene polymers, including a grafted ethylene copolymer; a tackifier; and two or more styrene polymers. The composition is useful as an adhesive or tie layer, inter alia.

Also provided are multilayer sheets and films in which the composition of the invention is used as a tie layer, and compound articles wherein two or more articles are adhered by the composition of the invention.

### DETAILED DESCRIPTION OF THE INVENTION

The following definitions apply to the terms as used throughout this specification, unless otherwise limited in specific instances.

The terms “finite amount” and “finite value”, as used herein, refer to an amount or value that is not equal to zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

All percentages, parts, ratios, and the like set forth herein are by weight, unless otherwise stated in specific instances.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

The composition of the invention comprises two or more ethylene copolymers, a grafted ethylene copolymer, a tackifier, and two or more styrene polymers. Alternatively, the composition may consist essentially of two or more ethylene copolymers, a grafted ethylene copolymer, a tackifier, and two or more styrene polymers.

Suitable ethylene polymers include ethylene homopolymers and copolymers of ethylene with at least one other olefin. Mixtures and blends of the ethylene polymers may also be used in the compositions of the invention.

Suitable olefin comonomers include hydrocarbons having from 3 to 20 carbon atoms and also having one or more unsaturated non-aromatic carbon-carbon bonds. The olefins may be straight chain, branched, or cyclic molecules. Examples of preferred ethylene copolymers include, but are not limited to, ethylene/propylene copolymers, ethylene/butene copolymers, ethylene/hexene copolymers, ethylene/octene copolymers, ethylene/styrene copolymers, ethylene/butene/octene copolymers, ethylene/propylene/norbornadiene copolymers and propylene/butene copolymers.

The ethylene copolymers may contain from 99.5 to 60 weight percent of copolymerized ethylene units, preferably 99.0 to 85 weight percent, based on the total weight of the ethylene copolymer. Complementarily, the ethylene copolymers may contain from 0.5 to 40 weight percent of copolymerized units of other olefin(s), preferably from 1 to 15 weight percent, based on the total weight of the ethylene copolymer.

The ethylene homopolymers and copolymers suitable for use in the present invention include, without limitation, high density polyethylene (HDPE), medium-density polyethylene (MDPE), low density polyethylene (LDPE), very low density polyethylene (VLDPE), ultra low density polyethylene (ULDPE), and linear low density polyethylene (LLDPE).

The melt index of ethylene copolymers suitable for use in the present inventions may range from 0.1 to 50 g/10 min, and preferably ranges from 0.5 to 10 g/10 min, when measured according to ASTM D1238 at 190° C., using a 2.16 kg weight.

The ethylene polymers can be made by any suitable process, whether conventional or non-conventional, including syntheses using constrained geometry catalysts, single site catalysts, or metallocene catalysts (terms which are used interchangeably herein); Ziegler-Nafta catalysts and other catalysts useful in “low pressure” and free radical polymerization processes.

More specifically, the density distinguishing abbreviations HDPE, LLDPE, VLDPE and ULDPE, as used herein, refer to “linear” polyethylenes, as distinct from highly branched short or long chain polyethylenes made by free-radical polymerization. Before the advent of metallocene catalysts, these terms and abbreviations referred only to linear resins made from processes using Ziegler-Natta type catalysts. Currently, however, the terms may also be used to refer to linear resins made by metallocene catalysis. Accordingly, in this disclosure, the polymerization catalyst will be identified if it is believed to be important to the polyethylene under discussion. Otherwise, the discussion refers to polyethylene produced by any process.

When referring to linear resins produced by Ziegler-Natta processes, the density ranges used herein are: HDPE, greater than 0.935 g/cm³; LLDPE, from greater than 0.91 to 0.935 g/cm³; VLDPE, from 0.85 to 0.91 g/cm³. For resins produced by other processes, the actual density or density range is specifically identified where relevant. For example, the term LDPE, as used herein, refers to polyethylene produced by free radical polymerization and having a density of from 0.91 to 0.935 g/cm³.

Polyethylenes that are made using metallocene catalysts (mPE) are preferred, as are combinations of mPE and LDPE. A description of suitable metallocene-catalyzed polyethylenes may be found in U.S. Pat. No. 6,545,091. Suitable mPE is available commercially, under the tradenames Exact and Exceed, from the ExxonMobile Chemical Company of Houston, Tex., and under the tradenames Affinity and Engage from The Dow Chemical Company of Midland, Mich.

The two or more ethylene polymers include at least one grafted ethylene copolymer. Grafted ethylene copolymers include ethylene copolymers, such as those that are described above, that have been modified with one or more “grafting monomers.” In some preferred embodiments, the grafted ethylene copolymer comprises a grafted linear low density polyethylene (LLDPE) that is the product of a metallocene-catalyzed process.

The grafting monomer may be selected from the group consisting of ethylenically unsaturated mono-, di- or polycarboxylic acids and ethylenically unsaturated carboxylic acid anhydrides. More specifically, suitable grafting monomers include, without limitation, acrylic acid, methacrylic acid, maleic acid, fumaric acid, nadic acid, itaconic acid, crotonic acid, itaconic anhydride, maleic anhydride and dimethyl maleic anhydride, and their derivatives, and mixtures of two or more of these. Examples of suitable derivatives include salts, amides, imides and esters of suitable acids. Particularly useful grafting monomers include maleic acid and maleic anhydride.

Some suitable methods for grafting monomers onto the polyethylenes are well known in the art. For example, grafting can be carried out in the melt without a solvent, as disclosed in European Patent Application No. 0,266,994; in solution; in dispersion; or in a fluidized bed. Melt grafting can be accomplished in a heated extruder, a Brabender or a Banbury mixer or other internal mixers or kneading machines, roll mills and the like. The grafting may be carried out in the presence or absence of a radical initiator, such as a suitable organic peroxide, organic perester or organic hydroperoxide. The grafted polymers may be recovered by any method that separates or utilizes the graft polymer that is formed. Thus, the graft polymer can be recovered in the form of precipitated fluff, pellets, powders and the like. Other grafting methods with particular relevance to mPE are described in U.S. Pat. No. 5,346,963. Non-conventional grafting methods may also be suitable for use in the invention.

The acid grafted resin is preferably grafted as uniformly as possible. The extent of grafting is such that the acid or anhydride groups comprise about 0.005 to about 5 wt %, preferably about 0.01 to about 3 wt %, and more preferably about 0.05 to about 3 wt % of the total weight of the modified polyethylene resin.

The adhesive composition of the invention also includes a tackifier. Suitable tackifiers include well known products available from commercial sources, although non-conventional tackifiers may also be suitable. Rosin tackifiers, for example, are described in the Kirk Othmer Encyclopedia of Chemical Technology, Interscience Publishers, Second Edition, Volume 17, pages 475-509. They include naturally occurring rosins and chemically modified rosin derivatives obtained by hydrogenation, dehydrogenation, isomerization, and the like. Rosin derivatives includes rosin esters and rosin acids. Rosin acids are typically derived from tall oil and can be mixtures of so called abietic types and primary types. Rosin esters are formed by esterifying rosin acid with a di-, tri-, or tetra-hydroxy aliphatic alcohol such as ethylene glycol, propylene glycol, glycerine, or pentaerythritol. The terpene resins are generally prepared by the polymerization of terpene hydrocarbons in the presence of Friedel-Crafts catalysts at moderately low temperatures. Petroleum resins, under which are classed aliphatic, alicyclic, and aromatic hydrocarbon resins, are described in the Kirk Othmer Encyclopedia of Chemical Technology, Interscience Publishers, Third Edition, Volume 12, page 852. They are generally prepared by polymerizing hydrocarbons containing 4 to 10 carbon atoms with selected Friedel Crafts catalysts. Higher or lower hydrocarbons may also be present. The product may be further partially or fully hydrogenated. Suitable aromatic resins can be prepared from polymerization of alpha methyl styrene, vinyl toluene, and/or indene monomers. Also suitable are cumarone-indene hydrocarbon resins, low-molecular styrene resins, or rosin hydrocarbon resins. Preferred tackifiers include fully or selectively hydrogenated hydrocarbons, particularly C9 hydrocarbons, and similar materials. Some preferred tackifiers are commercially available under the tradenames Arkon P or M series from Arakawa Chemical Industries, Ltd., of Osaka, Japan, or under the tradenames Regalite or Regalrez from the Eastman Chemical Company of Kingsport, Tenn.

The adhesive compositions further comprise at least one styrene polymer. Suitable styrene polymers include impact polystyrenes, such as high impact polystyrenes (HIPS), which have been modified in situ during polymerization or by further post-polymerization blending with a polybutadiene or styrene-butadiene elastomer for enhanced impact properties. Impact polystyrenes may contain butadiene levels up to 20 wt %, preferably up to 15 wt %, based on the total weight of the styrene polymer and depending on the degree of impact toughness required.

Also suitable are block copolymers in which at least one polymer block is mainly composed of at least one aromatic vinyl monomer and at least one polymer block is mainly composed of a conjugated diene or its hydrogenated derivative. These polymers may be represented by the general formula A-B or A-B-A, where “A” represents a polymer block derived from the aromatic vinyl monomer and “B” represents a polymer block derived from the conjugated diene or its hydrogenated derivative. Mixtures of block copolymers, e.g., mixtures of tri-block (A-B-A) and di-block (A-B) copolymers, are also useful and in some instances preferred.

Suitable styrene polymers also include polymers containing the monomer of at least one aromatic vinyl monomer and at least one monomer of conjugated diene or its hydrogenated derivative, where the monomers are assembled in a more random multiblock format than the A-B and A-B-A block copolymer structures discussed above. For example, any type of copolymerization structure of the monomers, such as random, block, or tapered, can be used.

Examples of suitable aromatic vinyl monomers include anionically polymerizable aromatic vinyl monomers such as styrene, 1-vinyl-naphthalene, 2-vinylnaphthalene, 3-methylstyrene, 4-propylstyrene, 4-cyclohexylstyrene, 4-dodecylstyrene, 2-ethyl-4-benzylstyrene, 4-(phenylbutyl)styrene and the like, and mixtures thereof. More preferred are styrene, α-methyl styrene, and mixtures thereof. Examples of suitable conjugated dienes include 1,4-butadiene, 1,2-butadiene and isoprene.

The weight ratios of the aromatic vinyl monomer component, e.g, styrene, to the conjugated diene component, e.g. isoprene or butadiene, can vary widely but will generally have the range of 20 to 50 weight percent of styrene and 80 to 50 weight percent of conjugated diene or its hydrogenated derivative, more preferably 25 to 45 weight percent of styrene and 75 to 55 weight percent of conjugated diene or its hydrogenated derivative, based on the total weight of the styrene block polymer.

The melt index range of the styrenic polymers, as measured by ASTM D1238 at Conditions G (200° C./5 kg) can range from less than 1 to 100 g/10 min, and preferably ranges from 1 to 50 g/10 min.

The block copolymers can be obtained by methods generally known in the art such as copolymerization in an inert solvent using a lithium catalyst. Examples of suitable methods are described in U.S. Pat. Nos. 3,149,182; 3,231,635; and 4,987,194. Alternatively, suitable styrenic polymers are commercially available. Sources of HIPS include NOVA Chemicals of Pittsburg, Pa. (Nova HIPS FX510, for example), Total Petrochemicals USA, Inc., of Houston, Tex. (Total 935, for example), and the Dow Chemical Company of Midland, Mich. (Styron 421, for example). Examples of di-, tri- and multiblock styrenic polymers may be obtained under the tradename Vector from Dexco Polymers LP of Houston, Tex., under the tradename Kraton from Kraton Polymers of Houston, Tex., under the tradename Stryoflex from BASF of Florham Park, N.J., and under the tradename Stereon from Firestone Polymers of Akron, Ohio.

The adhesive composition preferably comprises about 40% to about 70% by weight of the two or more ethylene copolymers. Also preferably, about 35 to about 65 wt % is a metallocene-catalyzed polyethylene (mPE). The adhesive composition may also optionally include a finite amount up to about 15%, preferably about 10% to about 15%, of a linear low density polyethylene (LDPE). These amounts are weight percentages based on the total weight of the adhesive composition. As described above, at least one of the ethylene copolymers is modified by grafting. The level of grafted ethylene polymer can be adjusted by one skilled in the art to include any level from 2 weight % to 60 weight percent, preferably 5 to 40 weight %, based on the total weight of the composition. The level of anhydride in the adhesive may range between 0.01 and 3 weight % anhydride, preferably between 0.03 and 0.50 weight %, based on the total weight of the adhesive composition.

The adhesive composition preferably comprises about 5% to about 25%, preferably about 5% to about 15% by weight of tackifier, based on the total weight of the adhesive composition.

The composition preferably comprises about 25% to about 45%, preferably 30% to 40% by weight of styrene polymers, based on the total weight of the adhesive composition. The styrene polymers include an ABA tri-block copolymer and one or both of a high impact polystyrene and an AB di-block or multi-block copolymer.

Furthermore, in adhesive compositions of the invention, the amount of tackifier and the amount of styrene polymer ABA block copolymer is preferably greater than or equal to about 8 wt %, based on the total weight of the adhesive composition.

The compositions of the invention may also include additives or other ingredients that are suitable for use in polymeric adhesive or tie layer compositions, whether conventional or non-conventional. For example, conventional additives include antioxidants, UV stabilizers, flame retardants, plasticizers, pigments, processing aids, and the like. Suitable levels of these additives and methods of incorporating these additives into polymer compositions will be known to those of skill in the art. See, e.g., the Modern Plastics Encyclopedia, McGraw-Hill, New York, N.Y. 1995.

Compositions of the invention may be made by any suitable means, whether presently known or yet to be discovered. Examples of suitable means include melt mixing process such as single screw extrusion, twin-screw extrusion or Banbury batch mixing.

Also provided are compound articles comprising two or more articles bonded together with the adhesive composition of the invention. These compound articles include, without limitation, containers such as cups, trays, tubs, sheets, tubes, films, bottles, shoes, items of sport equipment. Preferably, at least one of the articles included in the compound article comprises polystyrene.

Preferably, the adhesive composition of the invention is used as a tie layer in a multilayered film or sheet. The tie layer is disposed between two adjacent layers of film and bonds the film layers by adhering to each of them. The tie layer thus adjoins each of the two film layers and is preferably contiguous with one or both of them.

Also preferably, the multilayered film or sheet includes one or more layers comprising polystyrene, polyester, ethylene acid copolymers, ionomers of ethylene acid copolymers, ethylene vinyl acetate copolymers, polypropylene, EVOH, nylon, or PE. In these layers, recycled or reground polymeric materials may be used in complete or partial substitution for virgin polymeric materials. Reground materials may contain other components, such as adhesives or other polymers. For example, the contents of a layer of polystyrene that is produced from recycled or reground material may be mostly polystyrene; however, the “regrind” may also contain, tie layer materials, EVOH, or PE, for example.

The multilayered films or sheets are preferably formed in a coextrusion process. Information about extrusion processes will be available to those of skill in the art. See, for example, the Modern Plastics Encyclopedia or the Wiley Encyclopedia of Packaging Technology, 2d edition, A. L. Brody and K. S. Marsh, Eds., Wiley-Interscience (Hoboken, 1997). Some common coextrusion processes include blown film, cast film, extrusion coating blowmolding, and cast sheet processes. Coextrusion cast sheet is frequently formed thermally into cups, bowls and trays.

The following examples are provided to describe the invention in further detail. These examples, which set forth a preferred mode presently contemplated for carrying out the invention, are intended to illustrate and not to limit the invention.

### EXAMPLES

Unless otherwise noted in specific instances, melt indices (MI) and melt flow rates (MFR) were measured according to ASTM D1238 at 190° C., using a 2.16 kg weight. The values are reported in units of grams per 10 minutes.

A five layer coextruded cast sheet having the following structure was produced:
PS/Tie/EVOH/Tie/LDPE.
   Nominally, the thickness of each layer was 175/25/25/25/50 microns. Thus, the total thickness of the five-layer film was 300 microns.

The polystyrene layer was a 50/50 blend of HIPS (Styron™ 421) and general purpose polystyrene (GPPS, Styron™ 693W). The polystyrene was melted at 222° C. in a 63.5 mm single screw extruder operating at 62 RPM. The adhesive blends were melted at 209° C. in a 50.8 mm single screw extruder operating at 8 RPM. In the case of example 17 and comparative example 6, the adhesive blends were melted at 238° C. The EVOH grade was Eval J102B (available from the Eval Company of America, Houston, Tex.) and was melted at 226° C. in a 38.1 mm single screw operating at 24 RPM. The LDPE was DuPont DPE 1640 and was melted at 224° C. at 16 RPM. All four melt streams were fed through a Cloeren™ feedblock and die set at 218° C. The take up speed of the coextruded sheet was 6.4 m/min.

Table 1, below, sets forth the tie layer compositions that were tested and the resulting peel strengths. In Table 1, the Examples of the invention are numbered from 1 through 21; the comparative examples are numbered Comp1 through Comp7. The sheet was cut into strips 25.4 mm wide and about 150 mm long, and stored at 23° C. and 50% relative humidity (RH). Peel strength was measured 1 week after the sheet was produced. The values are reported as “AVG±STD DEV”, in which “AVG” is the average of measurements taken on 5 to 8 samples and “STD DEV” is the standard deviation of the measurements.

TABLE 1
Compositions and Results

| | | | | | | | | | | | | | | Peel |
|---|---|---|---|---|---|---|---|---|---|---|---|---|---|---|
| | PE Resins | | | | Grafted PE | | Tackifier | Styrene Polymer | | | | | | strength |
| Examples | Code | wt % | Code | w % | Code | w % | w % | Code | w % | Code | w % | Type | w % | g/25 mm |
| 1 | LLDPE1 | 32 | LDPE1 | 10 | GPE1 | 20 | 8 | ABA1 | 0 | AB3 | 15 | PS4 | 15 | 257 ± 47 |
| 2 | LLDPE1 | 32 | LDPE1 | 10 | GPE1 | 20 | 8 | ABA1 | 0 | AB3 | 30 | | | 847 ± 36 |
| 3 | LLDPE1 | 32 | LDPE1 | 10 | GPE1 | 20 | 8 | ABA1 | 0 | AB3 | 30 | | | 790 ± 83 |
| 4 | VLDPE2 | 42 | | 0 | GPE2 | 20 | 8 | ABA1 | 0 | AB3 | 0 | PS4 | 30 | 1785 ± 499 |
| 5 | LLDPE1 | 33 | LDPE1 | 10 | GPE1 | 20 | 12 | ABA1 | 0 | AB3 | 25 | | | 594 ± 55 |
| 6 | LLDPE1 | 38 | | 0 | GPE1 | 20 | 12 | ABA1 | 0 | AB3 | 15 | PS4 | 15 | 425 ± 28 |
| 7 | VLDPE1 | 42 | | 0 | GPE1 | 20 | 8 | ABA1 | 0 | AB3 | 0 | PS4 | 30 | 438 ± 146 |
| 8 | LLDPE2 | 36 | LDPE1 | 10 | GPE1 | 20 | 4 | ABA1 | 5 | AB3 | 25 | | | 573 ± 18 |
| 9 | LLDPE2 | 27 | LDPE1 | 10 | GPE1 | 20 | 8 | ABA1 | 5 | AB3 | 30 | | | 915 ± 88 |
| 10 | LLDPE1 | 38.5 | LDPE1 | 10 | GPE1 | 20 | 4 | ABA1 | 7.5 | AB3 | 20 | | | 164 ± 59 |
| 11 | LLDPE1 | 28.5 | LDPE1 | 10 | GPE1 | 20 | 4 | ABA1 | 7.5 | AB3 | 30 | | | 1167 ± 229 |
| 12 | LLDPE1 | 29.5 | LDPE1 | 10 | GPE1 | 20 | 8 | ABA1 | 7.5 | AB3 | 25 | | | 1487 ± 381 |
| 13 | LLDPE1 | 29.5 | LDPE1 | 10 | GPE1 | 20 | 8 | ABA1 | 7.5 | AB3 | 25 | | | 1087 ± 330 |
| 14 | LLDPE1 | 29.5 | LDPE1 | 10 | GPE1 | 20 | 8 | ABA1 | 7.5 | AB3 | 25 | | | 1017 ± 68 |
| 15 | LLDPE1 | 30.5 | LDPE1 | 10 | GPE1 | 20 | 12 | ABA1 | 7.5 | AB3 | 20 | | | 980 ± 87 |
| 16 | LLDPE1 | 20.5 | LDPE1 | 10 | GPE1 | 20 | 12 | ABA1 | 7.5 | AB3 | 30 | | | 684 ± 164 |
| 17 | LLDPE1 | 32 | LDPE1 | 10 | GPE1 | 20 | 8 | ABA2 | 10 | AB3 | 20 | | | 202 ± 45 |
| 18 | LLDPE1 | 26 | LDPE1 | 10 | GPE1 | 20 | 4 | ABA1 | 15 | AB3 | 25 | | | 455 ± 47 |
| 19 | LLDPE1 | 27 | LDPE1 | 10 | GPE1 | 20 | 8 | ABA1 | 15 | AB3 | 20 | | | 1326 ± 442 |
| 20 | LLDPE1 | 17 | LDPE1 | 10 | GPE1 | 20 | 8 | ABA1 | 15 | AB3 | 30 | | | 732 ± 203 |
| 21 | LLDPE1 | 18 | LDPE1 | 10 | GPE1 | 20 | 12 | ABA1 | 15 | AB3 | 25 | | | 319 ± 85 |
| Comp1 | LLDPE1 | 41 | LDPE1 | 10 | GPE1 | 20 | 4 | ABA1 | 0 | AB3 | 25 | | | 50 ± 4 |
| Comp2 | LLDPE1 | 42 | LDPE1 | 10 | GPE1 | 20 | 8 | ABA1 | 0 | AB3 | 20 | | | 56 ± 4 |
| Comp3 | LLDPE1 | 40 | LDPE1 | 10 | GPE1 | 20 | 0 | ABA1 | 5 | AB3 | 25 | | | 43 ± 9 |
| Comp4 | LDPE2 | 46 | | 0 | GPE1 | 20 | 4 | ABA1 | 5 | AB3 | 25 | | | 74 ± 25 |
| Comp5 | LLDPE1 | 36 | LDPE1 | 10 | GPE1 | 20 | 4 | ABA1 | 0 | AB3 | 30 | | | 118 ± 51 |
| Comp6 | LLDPE1 | 42 | LDPE1 | 10 | GPE1 | 20 | 8 | ABA2 | 20 | AB3 | 0 | | | 36 ± 3 |
| Comp7 | VLDPE3 | 30 | LDPE1 | 0 | GPE3 | 35 | 0 | ABA1 | 0 | AB3 | 35 | | | 29 ± 3 |

The following notes apply to Table 1:

1. Polyethylene (PE) types:
LLDPE1=metallocene LLDPE, density 0.918 g/cc, 1 MI
LLDPE2=Ziegler-Natta LLDPE, density 0.918 g/cc, 1 MI
VLDPE1=metallocene VLDPE, density 0.900 g/cc, 3 MI
VLDPE2=metallocene VLDPE, density 0.870 g/cc, 1 MI
VLDPE3=Ziegler-Natta VLDPE, density 0.902 g/cc, 5 MI
LDPE1=LDPE density 0.923 g/cc; 4.5 MI
LDPE2=LDPE density 0.923 g/cc; 2 MI

2. Grafted PE types:
GPE1=metallocene LLDPE graft, grafted to 0.95 w % maleic anhydride; 3 MI
GPE2=metallocene LLDPE graft, grafted to 0.90 w % maleic anhydride; 4 MI
GPE3=high density PE grafted to 0.90 w % maleic anhydride; 2 MI

3. Tackifier=alicyclic C9 tackifier with 123° C. softening point, as measured by the Ring & Ball method, density of 0.98 g/cc, weight average molecular weight of 1300 and number average molecular weight of 800.

4. Styrene Polymer Types:
ABA1=styrene-isoprene-styrene tri-block copolymer with 44 w % styrene, 35 MFR (ASTM D1238 200° C./5 kg)
ABA2=styrene-isoprene-styrene tri-block copolymer with 30 w % styrene, 13 MFR
AB3=styrene-butadiene multiblock copolymer with 45 w % styrene, 12 MFR (ASTM D1238 200° C./5 kg)
PS4=High impact PS 2.6 MFR (ASTM D1238 200° C./5 kg) with Notched Izod Strength of 230 J/m

These results demonstrate that the compositions of the invention are adhesive formulations with higher thermal resistance than EVA adhesives. Moreover, the adhesives of the invention provide excellent bonds to polystyrene in coextruded structures.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. An adhesive composition comprising
about 40% to 70% of ethylene polymers, said ethylene polymers comprising
about 2 to about 60% of a grafted ethylene copolymer that results from the modification of an ethylene copolymer with one or more grafting monomers selected from the group consisting of ethylenically unsaturated mono-, di- or polycarboxylic acids and ethylenically unsaturated carboxylic acid anhydrides, wherein the amount of grafting monomer units is about 0.01 to about 3%;
about 35 to about 68% of a metallocene-catalyzed ethylene copolymer; and
optionally, a finite amount up to about 15% of a low density polyethylene;
about 5% to about 25% of a tackifier; and
about 25% to about 45% of styrene polymers,
wherein the styrene polymers comprise a mixture of an ABA block copolymer and one or both of a high impact polystyrene and an AB block copolymer;
wherein the sum of the amount of the tackifier and the amount of the ABA block copolymer is greater than or equal to about 8%; and
further wherein all percentages are percentages by weight based on the total weight of the adhesive composition.

2. The adhesive composition of claim 1, wherein the grafted ethylene copolymer comprises a grafted linear low density polyethylene (LLDPE) that is the product of a metallocene-catalyzed process.

3. The adhesive composition of claim 1, wherein the ethylene polymers comprise about 10% to about 15% of the low density polyethylene (LDPE), by weight based on the total weight of the adhesive composition.

4. The adhesive composition of claim 1, comprising about 5% to about 15% of a tackifier, by weight based on the total weight of the adhesive composition.

5. The adhesive composition of claim 1, comprising about 30% to about 40% of styrene polymers, by weight based on the total weight of the adhesive composition.

6. A multilayer film or sheet, comprising a tie layer and, optionally, a second tie layer, said tie layer and said optional second tie layer comprising the adhesive composition of claim 1.

7. A multilayer film or sheet comprising at least two layers, a tie layer, and, optionally, a second tie layer, said tie layer and said optional second tie layer consisting essentially of the adhesive composition of claim 1.

8. The multilayer film or sheet of claim 6 or 7, wherein the tie layer adheres to a layer comprising a polystyrene, a polyester, an ethylene acid copolymer, an ionomer of an ethylene acid copolymer, an ethylene vinyl acetate copolymer, a polypropylene, an ethylene-vinyl alcohol copolymer, a nylon, or a polyethylene.

9. The multilayer film or sheet of claim 6 or 7, wherein the tie layer adheres to a layer comprising polystyrene.

10. The multilayer film or sheet of claim 9, wherein the layer is produced from recycled or reground material.

11. The multilayer film or sheet of claim 9, wherein the tie layer further adheres to a layer comprising a copolymer of ethylene and vinyl alcohol.

12. The multilayer film or sheet of claim 6 or 7, wherein the tie layer adheres to a layer comprising a copolymer of ethylene and vinyl alcohol.

13. The multilayer film or sheet of claim 12, wherein the tie layer further adheres to a layer comprising a polyethylene.

14. A multilayer film or sheet of claim 6 or 7, wherein the tie layer adheres a layer comprising a polystyrene to a layer comprising a copolymer of ethylene and vinyl alcohol, and further comprising a second tie layer adhering the layer comprising a copolymer of ethylene and vinyl alcohol to a layer comprising a polyethylene.

15. The multilayer film or sheet of claim 14, wherein one or more of the layer comprising polystyrene, the layer comprising a copolymer of ethylene and vinyl alcohol, and the layer comprising a polyethylene is produced from recycled or reground material.

16. The multilayer film or sheet of claim 6 or 7 that is formed by a coextrusion process.

17. The multilayer film or sheet of claim 16 wherein the coextrusion process is a blown film process, a cast film process, an extrusion coating process, a blowmolding process, or a cast sheet process.

18. A cast sheet of claim 17.

19. A cup, a bowl, or a tray that is that is formed from the cast sheet of claim 18.

20. A compound article comprising two or more component articles, at least two of said component articles being adhered by an adhesive comprising the composition of claim 1.

21. A compound article comprising two or more component articles, at least two of said component articles being adhered by an adhesive consisting essentially of the composition of claim 1.

22. The compound article of claim 20 or 21, wherein at least one of said two component articles comprises a polystyrene.

23. The compound article of claim 20 or 21, being a container, a cup, a tray, a tub, a sheet, a tube, a film, a bottle, a shoe, or an item of sport equipment.
